(19) United States
(12) Patent Application Publication
(10) Pub. No.: US 2024/0159323 A1
(43) Pub. Date: May 16, 2024

(54) Adjustable Flow Control Valve

(71) Applicants: Stephen Ray Tarte, Tampa, FL (US); Douglas Robert Ausdemore, Huntington Beach, CA (US)

(72) Inventors: Stephen Ray Tarte, Tampa, FL (US); Douglas Robert Ausdemore, Huntington Beach, CA (US)

(21) Appl. No.: 18/484,357

(22) Filed: Oct. 10, 2023

Related U.S. Application Data
(63) Continuation-in-part of application No. 29/865,112, filed on Jul. 8, 2022.
(60) Provisional application No. 63/378,984, filed on Oct. 10, 2022.

(51) Int. Cl. F16K 15/02

(52) U.S. Cl. CPC F16K 15/026

(57) ABSTRACT

The invention relates to an adjustable mechanical valve assembly used to control fluid flow in a pipe system that compresses air bubbles in the fluid to allow a more dense volume of fluid to exit the control valve. The valve assembly comprises a housing, a valve member, a spring member, and a retaining member. The spring member is configured to limit radial movement while allowing axial movement, thereby eliminating the need for a separate element (such as a rod) to limit radial movement.

### CLAIM TO PRIORITY

This application claims priority to U.S. design patent application 29/865,112, filed on 8 Jul. 2022, and provision application 63/378,984, filed on 10 Oct. 2022, the contents of which are hereby incorporated by this reference for all that they disclose for all purposes.

### TECHNICAL FIELD

The invention relates to an adjustable mechanical valve assembly used to control fluid flow in a pipe system that compresses air bubbles in the fluid to allow a more dense fluid volume to exit the control valve.

### BACKGROUND OF THE INVENTION

In physics and engineering, fluid dynamics is a subdiscipline of fluid mechanics that describes the flow of fluids (e.g., liquids, gases). Fluid dynamics has several subdisciplines, including aerodynamics and hydrodynamics. Fluid dynamics has a wide range of applications, including determining the mass flow rate of petroleum/water through pipelines associated with one or more control valves.

A flow control valve regulates the flow or pressure of a fluid. Control valves typically respond to signals generated by independent devices such as flow meters or temperature gauges. Prior art control valves are generally fitted with actuators and positioners. Such valves are often called automatic control valves, as the hydraulic actuators respond to pressure or flow changes to open/close the valve. Automatic control valves generally do not require an external power source, meaning the fluid pressure is enough to open and close them.

Automatic control valves include check valves. A check valve is a type of valve that allows a fluid liquid or gas to flow in a forward direction only. In reverse flow conditions, the valve closes to prevent flow. Prior art inline check valves generally have two ports, an inlet and an outlet, with self-contained mechanical controls. Thus, check valves work automatically, and most are not directly controlled by a person or any external control.

Prior art check valves generally have a valve that moves inside a valve housing as described above. The valve moves axially (i.e., in the same direction as fluid flow) between the valve input and the valve output. A particular component, such as a rod, in axial alignment between the valve input and the valve output, extends through the axial center of the valve member so that the valve member moves axially along the rod. Such a configuration is not optimal as the components wear over time, and there may be a need for a seal between the rod and the valve member. What is needed is a design that eliminates such a component.

An important concept in check valves is the “cracking pressure,” or the point of minimum upstream pressure at which the valve will operate. Typically, the check valve is designed for, and can therefore be specified for, a specific cracking pressure. For prior art devices, the valve is in the fully open position at higher flow rates and operates at predictable pressure drops, and flow streams can be accurately predicted. Notably, while a fluid does not compress easily, fluids such as water contain air bubbles that can be compressed. Further, when the water is being metered for consumption, the less air there is, the better. For configurations where the valve is installed upstream from a utility meter, a valve technology is needed to reduce undesired impurities in the fluid, such as air, before the cracking pressure is reached. When the cracking pressure is reached, a more dense fluid (fewer air bubbles) flows out of the valve and through the fluid meter, resulting in more fluid and less air being measured. Additionally, there is a need for a design where the valve can be easily adjusted to change the valve's cracking pressure. The technology disclosed and claimed in this document teaches such a device.

### SUMMARY OF THE INVENTION

Some of the objects and advantages of the invention will now be outlined in the following description, while other objects and advantages of the invention may be evident from the description or may be learned through the practice of the invention.

Additional objects and advantages of the present invention are outlined in the detailed description herein or will be apparent to those skilled in the art upon reviewing the detailed description. Also, it should be further appreciated that modifications and variations to the specifically illustrated, referenced, and discussed steps, or features hereof may be practiced in various uses and embodiments of this invention without departing from the spirit and scope thereof by virtue of the present reference thereto. Such variations may include but are not limited to the substitution of equivalent steps referenced or discussed and the functional, operational, or positional reversal of various features, steps, parts, or the like. Still, further, it is to be understood that different embodiments of this invention may include various combinations or configurations of presently disclosed features or elements or their equivalents, including combinations of features or parts or configurations thereof not expressly shown in the figures or stated in the detailed description.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which refers to the appended figures, in which:

FIG. 1 presents a perspective view of the input side of an assembled flow control valve;

FIG. 2 presents a perspective view of the output side of an assembled flow control valve;

FIG. 3 presents an exploded view of a flow control valve;

FIG. 4 presents a cut-away view of an assembled flow control valve showing the internal components of an assembled valve;

FIG. 5 presents a cut-away view of an empty housing;

FIG. 6 presents a side elevational view of a valve member;

FIG. 7 presents a rear perspective view of a valve member;

FIG. 8 presents a cut-away side elevational view of a spring member;

FIG. 9 presents an elevational view of the downstream side of a retaining member;

FIG. 10 presents an elevational view of the upstream side of a retaining member;

FIG. 11 presents a perspective view of the upstream side of a retaining member, showing a spring interface and retaining member voids;

FIG. 12 presents a plan view of a retaining member showing a retaining member interface;

FIG. 13 presents a cut-away side elevation view of a retaining member;

FIG. 14 presents a side elevation view of a tool for adjusting the position of the retaining member; and

FIG. 15 presents a top plan view of the tool depicted in FIG. 14.

### DISCLOSURE OF THE INVENTION

### DETAILED DESCRIPTION

Reference now will be made in detail to the embodiments of the invention, one or more examples of which are set forth below. Each example is provided by way of explaining the invention, not the limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent the same or analogous features, elements or steps. It is to be understood by one of ordinary skill in the art that the present discussion is a description of exemplary embodiments only and is not intended to limit the broader aspects of the present invention.

### Construction Aids

As used herein, unless stated otherwise, the terms “first,” “second,” and “third” may be used interchangeably to distinguish one component from another and are not intended to signify the location or importance of the individual components.

As used herein, the terms “upstream” and “downstream” refer to the relative location of components in a fluid pathway. For example, component A is upstream of component B if fluid flows from component A to component B. Conversely, component B is downstream of component A if component B receives a fluid flow from component A.

The actuation of the valve is controlled by forward and reverse opposing forces. When the flow is present, forward forces may include upstream pressure, seat opposing forces, and flow forces. Opposing forces may include downstream pressure, inertial forces, and spring forces when a spring is present.

As used herein, the term “axial” refers to a direction of flow through an object; the term “radial” refers to a direction extending away from the center of an object or normal to the “axial” direction, and the term “circumferential” refers to a direction extending around the circumference or perimeter of an object.

For the purposes of this document, unless otherwise stated, the phrase “at least one of A, B, and C” means there is at least one of A, or at least one of B, or at least one of C or any combination thereof not one of A, and one of B, and one of C.

As used in the claims, the definite article “said” identifies required elements that define the scope of embodiments of the claimed invention, whereas the definite article “the” merely identifies environmental elements that provide context for embodiments of the claimed invention that are not intended to be a limitation of any claim.

This document includes headers that are used for place markers only. Such headers are not meant to affect the construction of this document, do not in any way relate to the meaning of this document, nor should such headers be used for such purposes.

While the examples herein may be directed to a water delivery system comprising a meter measuring water consumption, the disclosed technology may be used to control fluid flow in any type of fluid delivery system.

### Description

As noted previously, a check valve is a type of valve designed to allow a fluid (liquid or gas) to flow in a forward direction only. In reverse flow conditions, the valve closes to prevent flow. Inline prior art mechanical check valves are generally self-contained and have an inlet and an outlet port where the actuation of the valve is controlled by forward and reverse opposing forces. Forward forces include upstream pressure, seat opposing forces, and flow forces when the flow is present. Opposing forces include downstream pressure, inertia forces, and spring forces when a spring is present. When upstream forces overcome downstream forces, the valve opens, and fluid flows through the valve. For example, a utility may supply water to a home via a pipeline comprising a meter to measure consumption. Such utility is “upstream” from the home as the utility supplies fluid to the home. A check valve may also be placed into the pipeline, perhaps upstream from a utility meter, so fluid can only flow from the utility pipeline to the home.

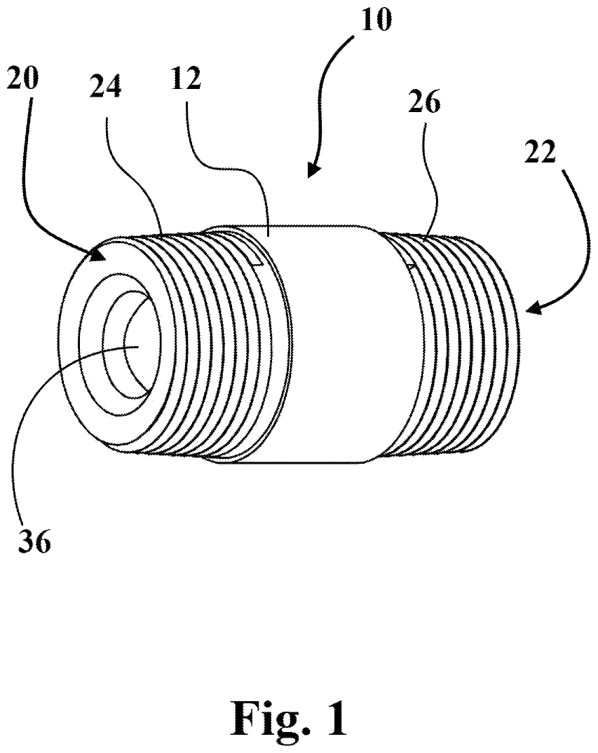

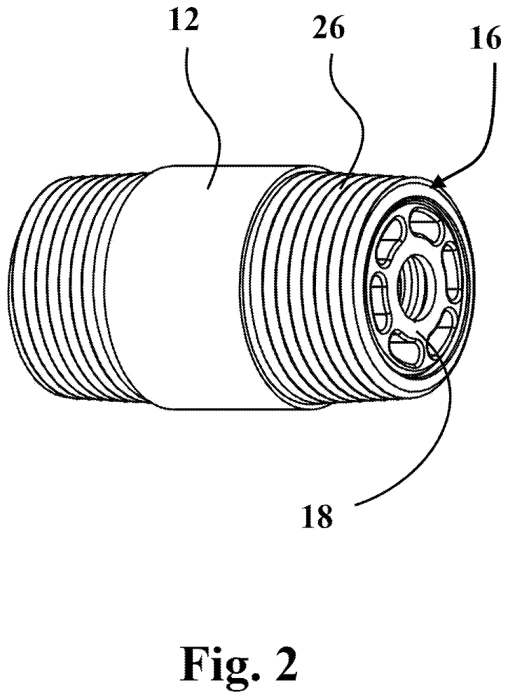

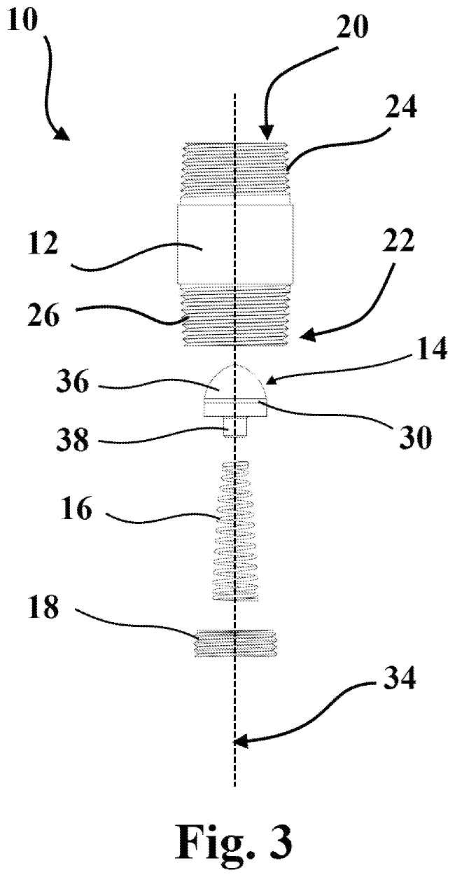

Referring more particularly to FIG. 1 through FIG. 4, and as best seen in FIG. 3, one embodiment of a flow control valve 10 for regulating fluid flow through a pipe system is presented. The flow control valve 10 generally comprises a hollow housing 12, a valve member 14, a spring member 16, and a retaining member 18. The housing 12 has a housing input 20 in axial alignment with a housing output 22. The housing input 20 may be configured to connect to or be placed in fluid communication with a fluid delivery system such as a water utility supply line. More specifically, for a typical installation, the flow control valve 10 would be installed upstream of a water utility meter that meters fluid consumption. For the embodiment depicted in FIG. 1, at least a portion of the outer surface of the housing 12 at the housing input 20 defines outer input threads 24. Similarly, at least a portion of the outer surface of the housing 12, at the housing output 22, defines outer output threads 26. The housing 12 outer perimeter and inner perimeter may define any shape or combination of shapes. For the current embodiment, the housing 12 defines an at least partially cylindrical outer perimeter and an at least partially cylindrical inner perimeter.

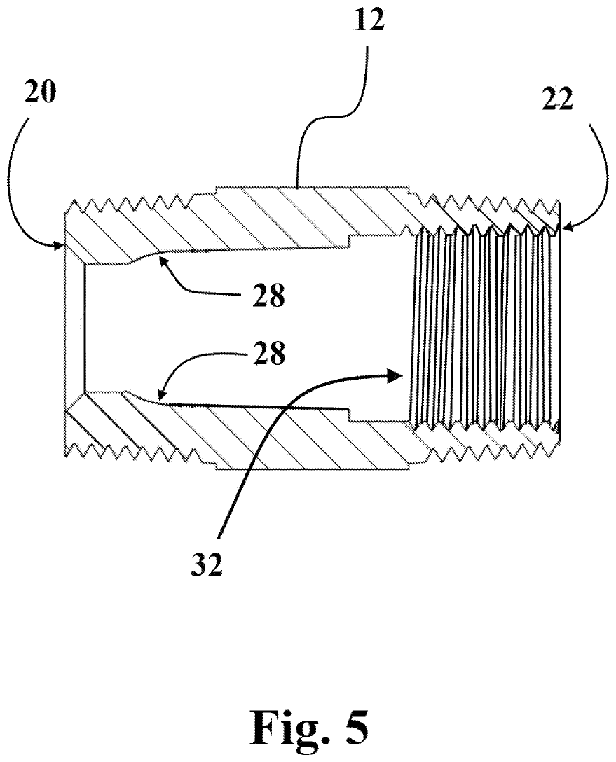

As best seen in FIG. 5, at least a portion of the inner surface of housing 12 defines or is associated with a valve seat 28. Thus, the valve seat 28 may be an integral part of housing 12 or a component associated with housing 12. The Valve seat 28 is at or downstream of the housing input 20. The valve seat 28 extends around the inner surface to define a circular ring or band shape. The valve seat 28 is configured for engaging a valve seal 30 described in more detail below.

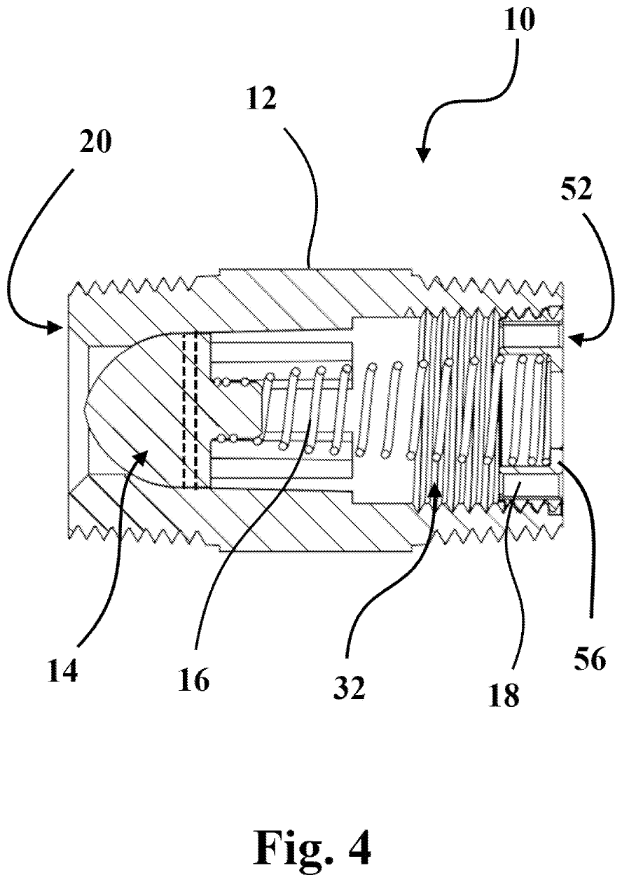

As best seen in FIG. 4 and FIG. 5, the housing 12 further defines output inner threads 32 located at or upstream from the housing output 22. The output inner threads 32 are configured to adjustably receive the retaining member 18.

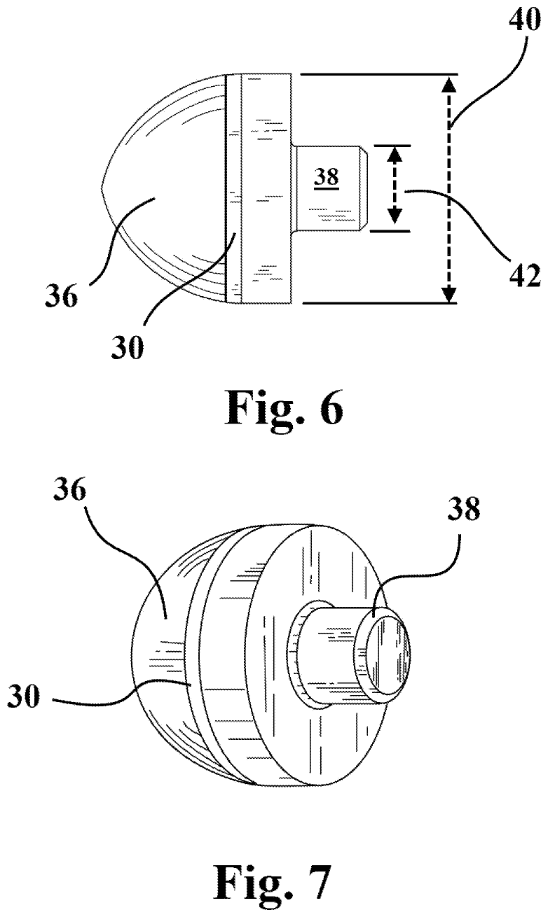

Referring now to FIG. 4, FIG. 6 and FIG. 7, the valve member 14 is considered in more detail. The valve member 14 may have a head section 36 and a depending base section 38 that extends axially away from the head section 36, as shown in FIG. 6. The head section 36 defines a head section diameter 40, and the depending base section 38 defines a depending base diameter 42 that is smaller than the head section diameter 40. The head section 36 may further define a valve seal 30 along a portion of the outer surface of head section 36. The valve seal 30 may be configured to engage the valve seat 28 to prevent fluid flow around the valve seal 30 when the valve seal 30 is engaging the valve seat 28. The valve seal 30 may be a portion of the outer surface of the head section 36. Alternatively, the valve seal 30 may be a separate component associated with the outer surface of the head section 36. Any sealing technology may be used, including O-Rings made of materials such as Buna-N, Alias®, butyl, fluorocarbon, fluorosilicone, hydrogenated nitrile, silicone rubber, neoprene, polyurethane, Kalrez® and PTFE materials. The valve member 14 is disposed inside the housing 12 and may be sized to move axially inside the housing 12 between the housing input 20 and the housing output 22.

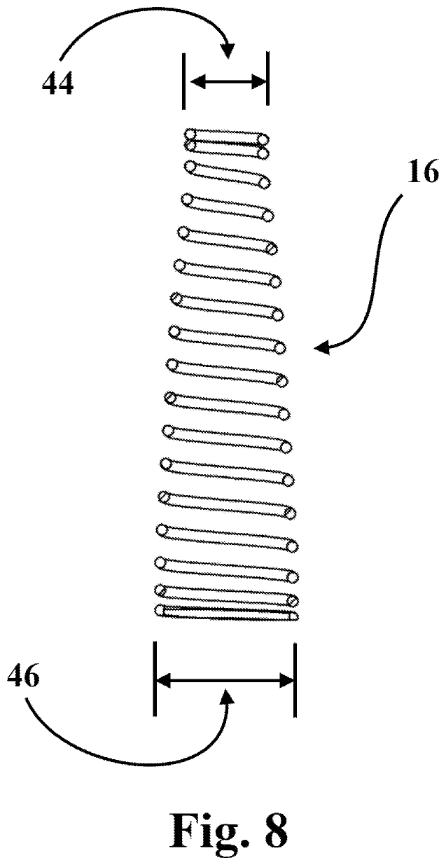

Referring now to FIG. 8, a cut-away side elevation view of a spring member 16 is presented. The spring member 16 has an upstream end and a downstream end. The upstream spring member diameter 44 is smaller than the downstream spring member diameter 46, thereby defining a conical spring member. As best seen in FIG. 4, the upstream spring member diameter 44 is slightly larger than the depending base diameter 42 so that the upstream end of the spring member fits snugly around the depending base section 38. The spring member 16 downstream end may be configured to engage the retaining member 18, as described in detail later. One of ordinary skill in the art will appreciate that the spring member 16 places a preload on the valve member 14 that upstream forces must overcome before the flow control valve 10 will allow fluid to pass through the valve. Further, the farther the retaining member 18 is moved in the upstream direction, the more preload the spring member 16 will be placed on valve member 14.

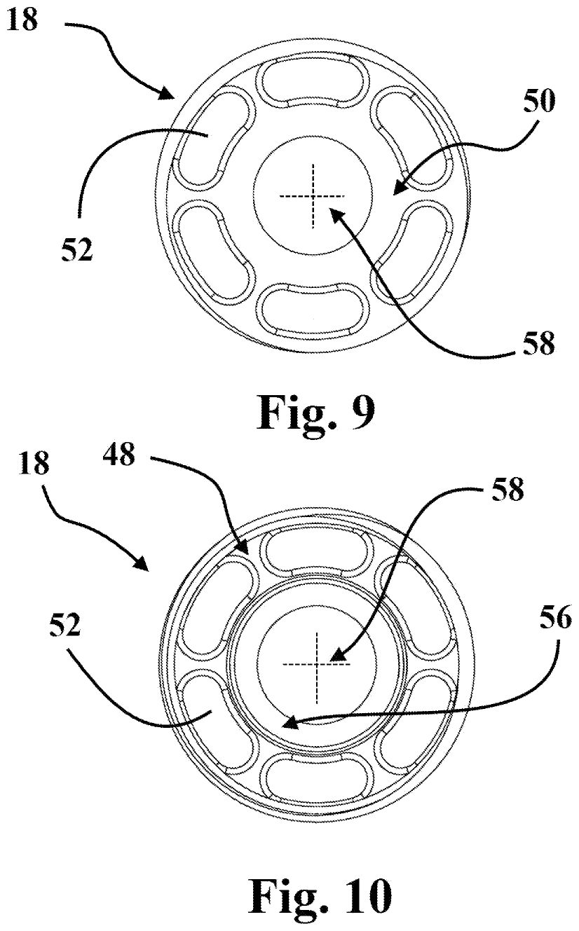

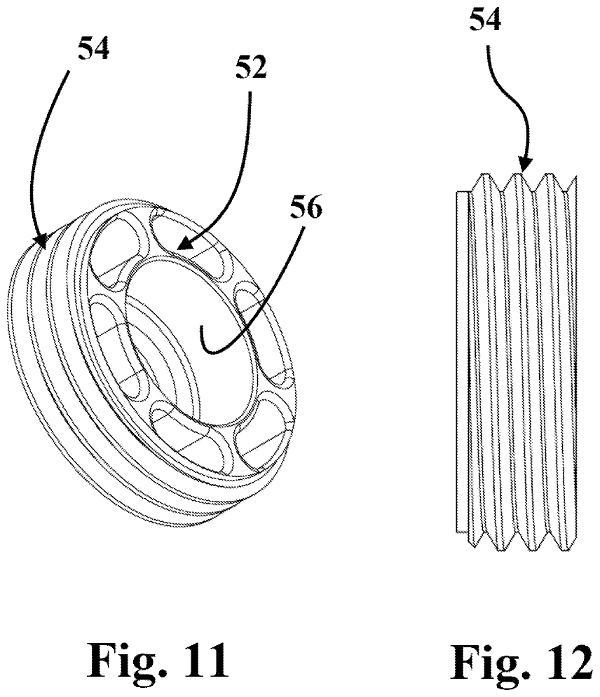

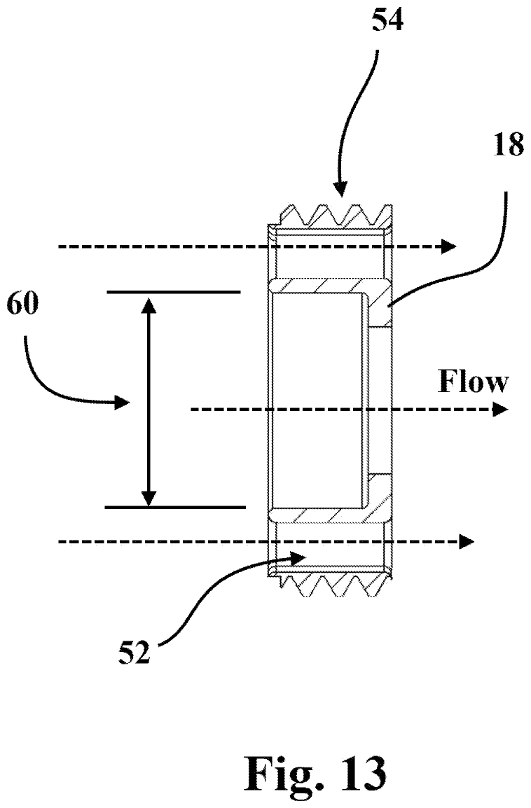

Referring now more particularly to FIG. 9 through FIG. 13, the retaining member 18 is considered. The retaining element 18 defines an inner retaining member surface 48 (FIG. 10) and an opposing outer retaining member surface 50 (FIG. 9) with a plurality of retaining member voids 52 defined therethrough to allow fluid to exit the flow control valve 10. The perimeter of retaining element 18 may further define a retaining member interface 54 (FIG. 12) configured to adjustably associate with the output inner threads 32 to allow axial movement for the retaining member 18. As best seen in FIG. 11, the inner retaining member surface 48 defines or is associated with a spring interface 56 configured to engage the downstream end of the spring member 16. The spring interface diameter is slightly larger than the downstream spring end diameter 46, allowing the downstream spring end to fit inside the spring interface 56.

The retaining member 18 defines a plurality of retaining member voids 52 between the axial center of the retaining member 18 and the retaining member 18 outer perimeter. There are six equally sized retaining member voids 52 for the current embodiment. In addition, one axial void 58 may be defined at the axial center of retaining member 18.

As noted above, the position of retaining element 18 is adjustable to change the amount of preload the spring member 16 places on the valve member 14. The preload opposes valve member 14 downstream movement. The actuation of the valve is controlled by forward forces and reverse opposing forces. Forward forces may include upstream pressure and flow forces when the flow is present. Opposing forces may include downstream pressure, inertia forces, and spring member 16 forces.

The valve opens when upstream forces overcome downstream forces, thereby allowing fluid flow through the valve. More particularly, when the fluid pressure upstream of the housing input 20 is greater than the fluid pressure at the housing output 22 plus the preload value (and any other reverse flow forces), the valve member 14 will begin to move axially toward the housing output 22 which will cause the valve seal 30 to disengage from the valve seat 28. As a result, fluid starts flowing around the valve member 14 head section 36, causing the difference in fluid pressure between the housing input 20 and housing output 22 to decrease below the preload value. Such results in the valve member 14 moving axially toward the valve input 20 until the valve seal 30 engages the valve seat 28 and fluid flow around the valve member 14 head section 36 stops.

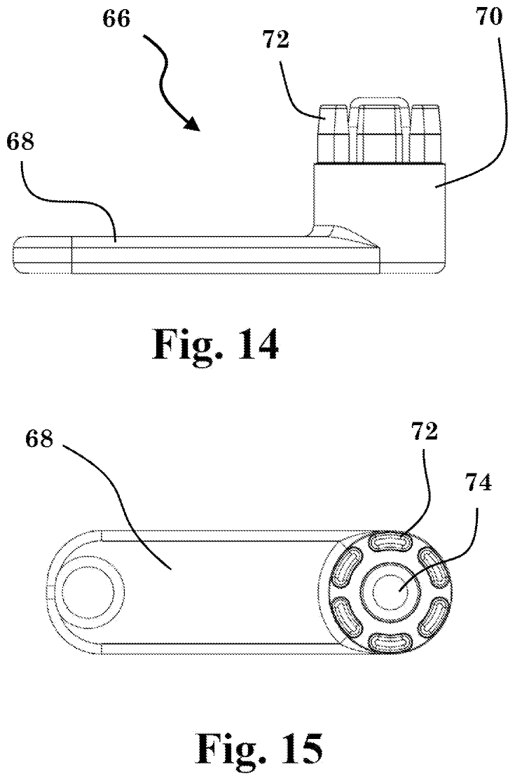

Referring now to FIG. 14 and FIG. 15, a tool for adjusting the position of retaining element 18 within housing 12. One exemplary tool may comprise a tool handle 68 defining a tool head 70 extending perpendicularly therefrom. As previously disclosed, the retaining member 18 defines a plurality of retaining member voids 52 between the axial center of the retaining member 18 and the retaining member 18 outer perimeter. The tool head may define a plurality of tool head pegs 72 extending around the perimeter of the tool head 70. For one embodiment, the tool head may futher define a center peg 74.

As disclosed above, for the current embodiment, there are six equally sized retaining member voids 52 and one axial void 58 at the axial center of retaining member 18. The tool head 70 may define six tool head pegs 72 configured to fit inside the voids 52, and a center peg 74 configured to find in the axial void 58. Notably, only 2 tool head pegs 72 are required to interface with and adjust retaining member 18. To adjust the position of retaining membe 18 inside housing 20, the tool head pegs 72 are inserted into voids 52 and tool handle 68 is used to rotate the tool head 70. Rotating tool head 70 in a first direction will cause the retaining member 18 to move towared the housing input 20, thereby increasing the preload that spring member 16 places on the valve member 14. Roating tool head 70 in a second direction (e.g., opposition direction) will cause the retaining member 18 to move towared the housing output 22, thereby decreasing the preload that spring member 16 places on the valve member 14.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should, therefore, not be limited by the above-described embodiment, method, and examples, but by all embodiments and methods within the scope and spirit of the invention as claimed.

What is claimed is:

1. A valve for regulating fluid flow through a pipe system, said valve comprising:
a hollow housing having a housing input and a housing output wherein said housing input is configured to connect to a fluid delivery system;
a valve seat located downstream from the housing input;
a retainer interface located at or upstream from the housing output;
a valve member disposed inside of said housing and sized to move axially inside of said housing, said valve member having a head section and a depending base section that extends axially away from said head section, wherein said head section defines a valve head diameter and said depending base section defines a depending base diameter that is smaller than said head diameter;
a valve seal defined along a portion of the outer surface of said head section and configured to create a sealing engagement with said valve seat to prevent fluid flow around said valve seal when said valve seal is engaging said valve seat;
a spring member disposed inside of said housing downstream from said valve member, said spring member having an upstream spring end defining an upstream spring end diameter that is larger than said depending base diameter and a downstream spring end defining a downstream spring end diameter that is larger than the upstream spring end diameter and wherein said depending base section extends into said upstream spring end;
a retaining member disposed downstream of said spring member and adjustably associated with said retainer interface wherein said retaining element defines an inner retaining member surface and an opposing outer retaining member surface with a plurality of retaining member voids defined therethrough to allow fluid to exit said housing, and wherein said downstream spring end is associated with said inside retainer surface thereby placing a preload pressure on said valve member; and
wherein the position of said retaining element is adjustable to change said preload pressure and wherein said valve member moves toward said valve output when the upstream pressure at said housing input is greater than the downstream pressure at said housing output plus said preload pressure, thereby allowing fluid flow through the valve.

2. The valve for regulating fluid flow as in claim 1, wherein said valve seat defines a circular valve seat, said head section defines an umbrella shape, and said valve seal defines a circular valve seal.

3. The valve for regulating fluid flow as in claim 1, wherein said valve seat defines a circular valve seat, said head section defines a bullet shape, and said valve seal defines a circular valve seal.

4. The valve for regulating fluid flow as in claim 3, further comprising a valve seal seat defined by the head section and configured to receive said valve seal.

5. The valve for regulating fluid flow as in claim 1, wherein said depending base defines a solid cylindrical body.

6. The valve for regulating fluid flow as in claim 1, wherein said depending base defines a hollow cylindrical body.

7. The valve for regulating fluid flow as in claim 1, wherein said retainer interface comprises inner threads at the housing output and wherein said retaining member is a retaining plate defining male threads along its parameter.
